(19) United States
(12) Patent Application Publication
(10) Pub. No.: US 2015/0379275 A1
(43) Pub. Date: Dec. 31, 2015

(54) PRIVACY AGAINST INFERENCE ATTACKS FOR LARGE DATA

(71) Applicant: THOMSON LICENSING, Issy-les-Moulineaux (FR)

(72) Inventors: Nadia FAWAZ, Santa Clara, CA (US); Salman SALAMATIAN, Ferney-Voltaire (FR); Flavio Du Pin CALMON, Cambridge, MA (US); Subrahmanya Sandilya BHAMIDIPATI, Palo Alto, CA (US); Pedro Carvalho OLIVEIRA, Freixianda (PT); Nina Anne TAFT, San Francisco, CA (US); Branislav KVETON, San Jose, CA (US)

(21) Appl. No.: 14/765,601

(22) PCT Filed: Feb. 4, 2014
(86) PCT No.: PCT/US2014/014653

§ 371 Date: Aug. 4, 2015

Related U.S. Application Data
(60) Provisional application No. 61/762,480, filed on Feb. 8, 2013.

(51) Int. Cl. G06F 21/60; G06F 17/30

(52) U.S. Cl. CPC G06F 21/60; G06F 17/30598

(57) ABSTRACT

A methodology to protect private data when a user wishes to publicly release some data about himself, which is correlated with his private data. Specifically, the method and apparatus teach combining a plurality of public data into a plurality of data clusters in response to the combined public data having similar attributes. The generated clusters are then processed to predict a private data wherein said prediction has a certain probability. At least one of said public data is altered or deleted in response to said probability exceeding a predetermined threshold.

### CROSS REFERENCE TO RELATED APPLICATION

This application claims priority to and all benefits accruing from a provisional application filed in the United States Patent and Trademark Office on Feb. 8, 2013, and there assigned Ser. No. 61/762,480.

### BACKGROUND OF THE INVENTION

1. Field of the Invention

The present invention generally relates to a method and an apparatus for preserving privacy, and more particularly, to a method and an apparatus for generating a privacy preserving mapping mechanism in light of a large amount of public data points generated by a user.

2. Background Information

In the era of Big Data, the collection and mining of user data has become a fast growing and common practice by a large number of private and public institutions. For example, technology companies exploit user data to offer personalized services to their customers, government agencies rely on data to address a variety of challenges, e.g., national security, national health, budget and fund allocation, or medical institutions analyze data to discover the origins and potential cures to diseases. In some cases, the collection, the analysis, or the sharing of a user's data with third parties is performed without the user's consent or awareness. In other cases, data is released voluntarily by a user to a specific analyst, in order to get a service in return, e.g., product ratings released to get recommendations. This service, or other benefit that the user derives from allowing access to the user's data may be referred to as utility. In either case, privacy risks arise as some of the collected data may be deemed sensitive by the user, e.g., political opinion, health status, income level, or may seem harmless at first sight, e.g., product ratings, yet lead to the inference of more sensitive data with which it is correlated. The latter threat refers to an inference attack, a technique of inferring private data by exploiting its correlation with publicly released data.

In recent years, the many dangers of online privacy abuse have surfaced, including identity theft, reputation loss, job loss, discrimination, harassment, cyberbullying, stalking and even suicide. During the same time accusations against online social network (OSN) providers have become common alleging illegal data collection, sharing data without user consent, changing privacy settings without informing users, misleading users about tracking their browsing behavior, not carrying out user deletion actions, and not properly informing users about what their data is used for and whom else gets access to the data. The liability for the OSNs may potentially rise into the tens and hundreds of millions of dollars.

One of the central problems of managing privacy in the Internet lies in the simultaneous management of both public and private data. Many users are willing to release some data about themselves, such as their movie watching history or their gender; they do so because such data enables useful services and because such attributes are rarely considered private. However users also have other data they consider private, such as income level, political affiliation, or medical conditions. In this work, we focus on a method in which a user can release her public data, but is able to prevent against inference attacks that may learn her private data from the public information. Our solution consists of a privacy preserving mapping, which informs a user on how to distort her public data, before releasing it, such that no inference attacks can successfully learn her private data. At the same time, the distortion should be bounded so that the original service (such as a recommendation) can continue to be useful.

It is desirable to a user to obtain the benefits of the analysis of publicly released data, such as movie preferences, or shopping habits. However, it is undesirable if a third party can analyze this public data and infer private data, such as political affiliation or income level. It would be desirable for a user or service to be able to release some of the public information to obtain the benefits, but control the ability of third parties to infer private information. A difficult aspect of this control mechanism is that often very large amounts of public data are released by users, and analysis of all of this data to prevent the release of private data is computationally prohibitive. It is therefore desirable to overcome the above difficulties and provide a user with an experience that is safe for private data.

### SUMMARY OF THE INVENTION

In accordance with an aspect of the present invention, an apparatus is disclosed. According to an exemplary embodiment, the apparatus comprises a memory for storing a plurality of user data wherein the user data comprises a plurality of public data, a processor for grouping said plurality of user data into a plurality of data clusters wherein each of said plurality of data clusters consists of at least two of said user data; said processor further operative to determine a statistical value in response to an analysis of said plurality of data clusters wherein said statistical value represents the probability of an instance of a private data, said processor further operative to alter at least one of said user data to generate an altered plurality of user data, and a transmitter for transmitting said altered plurality of user data.

In accordance with another aspect of the present invention, a method for protecting private data is disclosed. According to an exemplary embodiment, the method comprises the steps of accessing the user data wherein the user data comprises a plurality of public data, clustering the user data into a plurality of clusters, and processing the clusters of data to infer a private data, wherein said processing determines a probability of said private data;

In accordance with another aspect of the present invention, a second method for protecting private data is disclosed. According to an exemplary embodiment, the method comprises the steps of compiling a plurality of public data wherein each of said plurality of public data consist of a plurality of characteristics, generating a plurality of data clusters wherein said data clusters consist of at least two of said plurality of public data and wherein said at least two of said plurality of public data each having at least one of said plurality of characteristics, processing said plurality of data clusters to determine a probability of a private data, and altering at least one of said plurality of public data to generate an altered public data in response to said probability exceeding a predetermined value.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a flow diagram depicting an exemplary method for preserving privacy, in accordance with an embodiment of the present principles.

FIG. 2 is a flow diagram depicting an exemplary method for preserving privacy when the joint distribution between the private data and public data is known, in accordance with an embodiment of the present principles.

FIG. 3 is a flow diagram depicting an exemplary method for preserving privacy when the joint distribution between the private data and public data is unknown and the marginal probability measure of the public data is also unknown, in accordance with an embodiment of the present principles.

FIG. 4 is a flow diagram depicting an exemplary method for preserving privacy when the joint distribution between the private data and public data is unknown but the marginal probability measure of the public data is known, in accordance with an embodiment of the present principles.

FIG. 5 is a block diagram depicting an exemplary privacy agent, in accordance with an embodiment of the present principles.

FIG. 6 is a block diagram depicting an exemplary system that has multiple privacy agents, in accordance with an embodiment of the present principles.

FIG. 7 is a flow diagram depicting an exemplary method for preserving privacy, in accordance with an embodiment of the present principles.

FIG. 8 is a flow diagram depicting a second exemplary method for preserving privacy, in accordance with an embodiment of the present principles.

The exemplifications set out herein illustrate preferred embodiments of the invention, and such exemplifications are not to be construed as limiting the scope of the invention in any manner.

### DESCRIPTION OF THE PREFERRED EMBODIMENTS

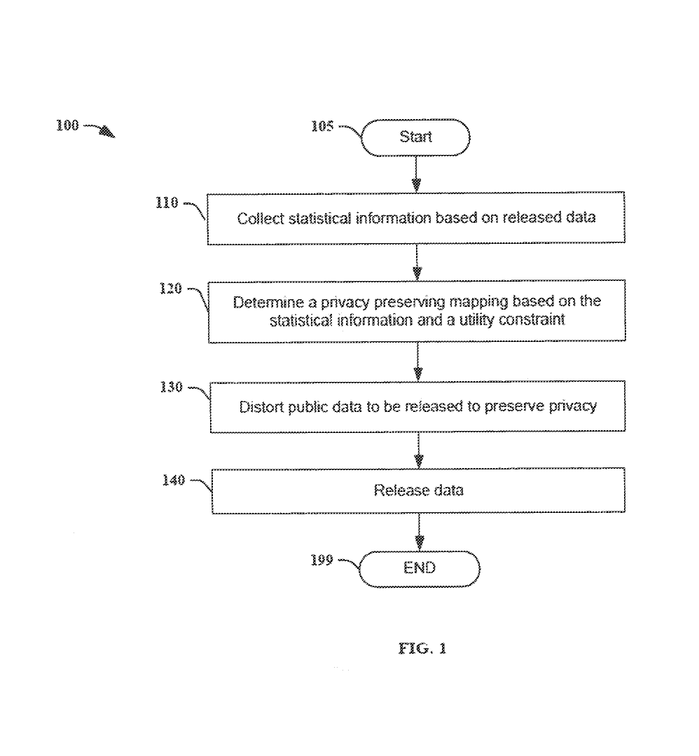

Referring now to the drawings, and more particularly to FIG. 1, a diagram of an exemplary method 100 for implementing the present invention is shown.

FIG. 1 illustrates an exemplary method 100 for distorting public data to be released in order to preserve privacy according to the present principles. Method 100 starts at 105. At step 110, it collects statistical information based on released data, for example, from the users who are not concerned about privacy of their public data or private data. We denote these users as “public users,” and denote the users who wish to distort public data to be released as “private users.”

The statistics may be collected by crawling the web, accessing different databases, or may be provided by a data aggregator. Which statistical information can be gathered depends on what the public users release. For example, if the public users release both private data and public data, an estimate of the joint distribution P_{S,X} can be obtained. In another example, if the public users only release public data, an estimate of the marginal probability measure P_{X} can be obtained, but not the joint distribution P_{S,X}. In another example, we may only be able to get the mean and variance of the public data. In the worst case, we may be unable to get any information about the public data or private data.

At step 120, the method determines a privacy preserving mapping based on the statistical information given the utility constraint. As discussed before, the solution to the privacy preserving mapping mechanism depends on the available statistical information.

At step 130, the public data of a current private user is distorted, according to the determined privacy preserving mapping, before it is released to, for example, a service provider or a data collecting agency, at step 140. Given the value X=x for the private user, a value Y=y is sampled according to the distribution P_{Y|X=x}. This value y is released instead of the true x. Note that the use of the privacy mapping to generate the released y does not require knowing the value of the private data S=s of the private user. Method 100 ends at step 199.

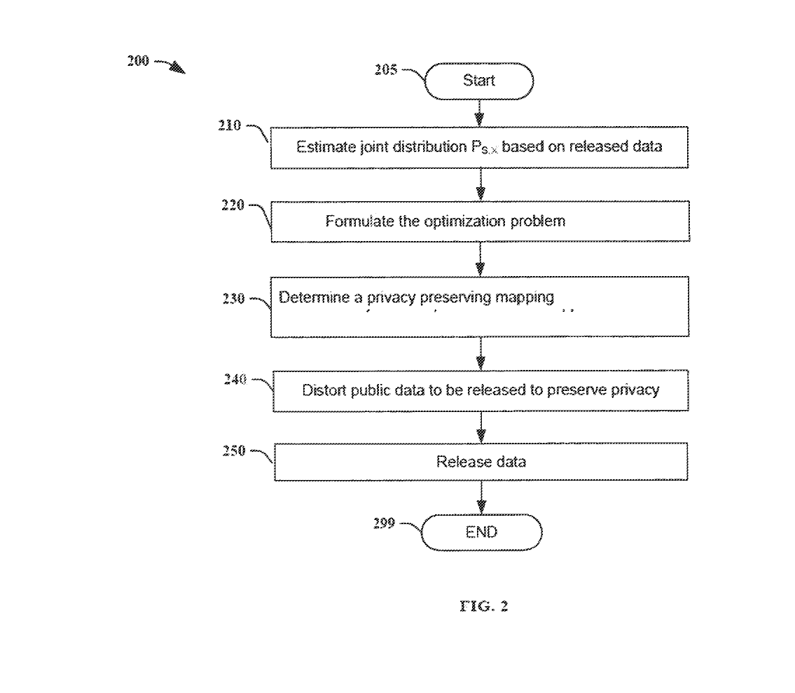

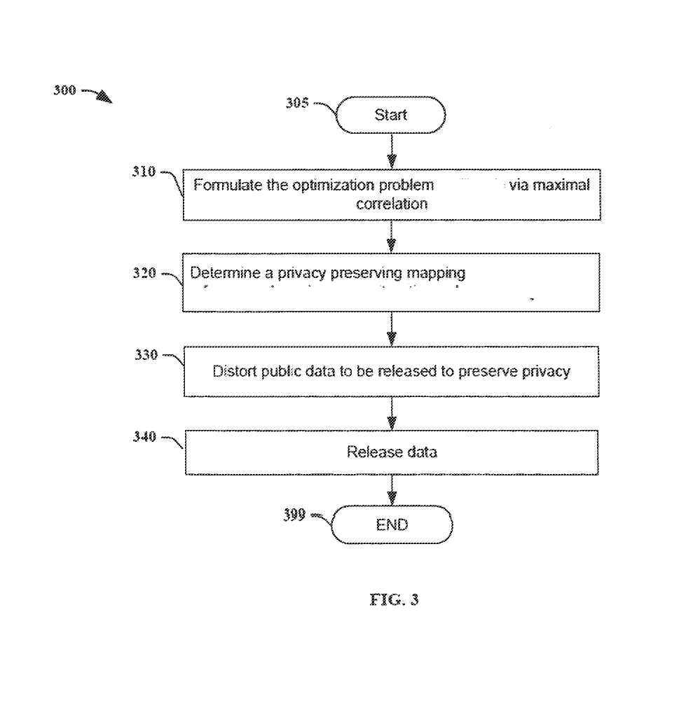

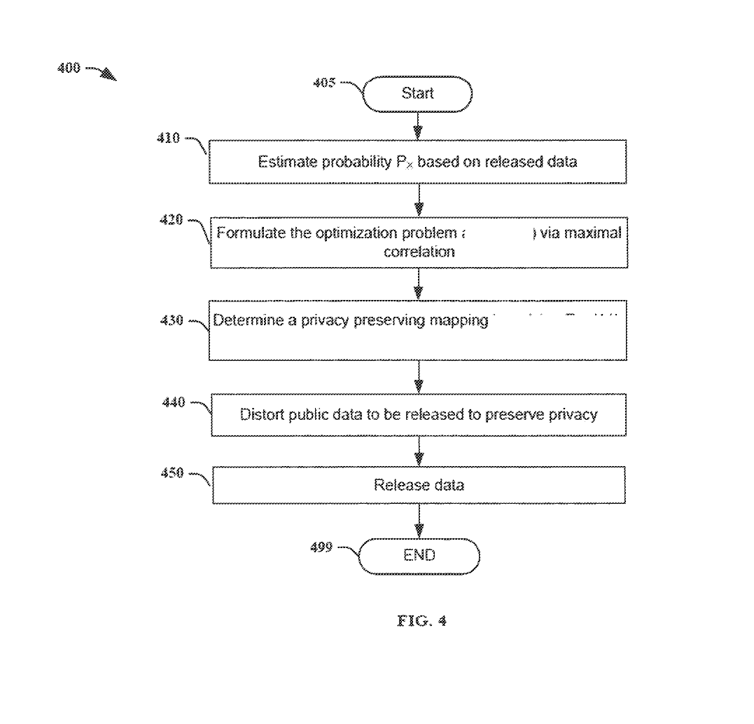

FIGS. 2-4 illustrate in further detail exemplary methods for preserving privacy when different statistical information is available. Specifically, FIG. 2 illustrates an exemplary method 200 when the joint distribution P_{S,X} is known, FIG. 3 illustrates an exemplary method 300 when the marginal probability measure Pₓ is known, but not joint distribution P_{S,X} , and FIG. 4 illustrates an exemplary method 400 when neither the marginal probability measure P_{X} nor joint distribution P_{S,X} is known. Methods 200, 300 and 400 are discussed in further detail below.

Method 200 starts at 205. At step 210, it estimates joint distribution P_{S,X} based on released data. At step 220, the method is used to formulate the optimization problem. At step 230 a privacy preserving mapping based is determined , for example, as a convex problem. At step 240, the public data of a current user is distorted, according to the determined privacy preserving mapping, before it is released at step 250. Method 200 ends at step 299.

Method 300 starts at 305. At step 310, it formulates the optimization problem via maximal correlation. At step 320, it determines a privacy preserving mapping based, for example, by using power iteration or Lanczos algorithm. At step 330, the public data of a current user is distorted, according to the determined privacy preserving mapping, before it is released at step 340. Method 300 ends at step 399.

Method 400 starts at 405. At step 410, it estimates distribution P_{X} based on released data. At step 420, it formulates the optimization problem via maximal correlation. At step 430, it determines a privacy preserving mapping, for example, by using power iteration or Lanczos algorithm. At step 440, the public data of a current user is distorted, according to the determined privacy preserving mapping, before it is released at step 450. Method 400 ends at step 499.

A privacy agent is an entity that provides privacy service to a user. A privacy agent may perform any of the following:
receive from the user what data he deems private, what data he deems public, and what level of privacy he wants;
compute the privacy preserving mapping;
implement the privacy preserving mapping for the user (i.e., distort his data according to the mapping); and
release the distorted data, for example, to a service provider or a data collecting agency.

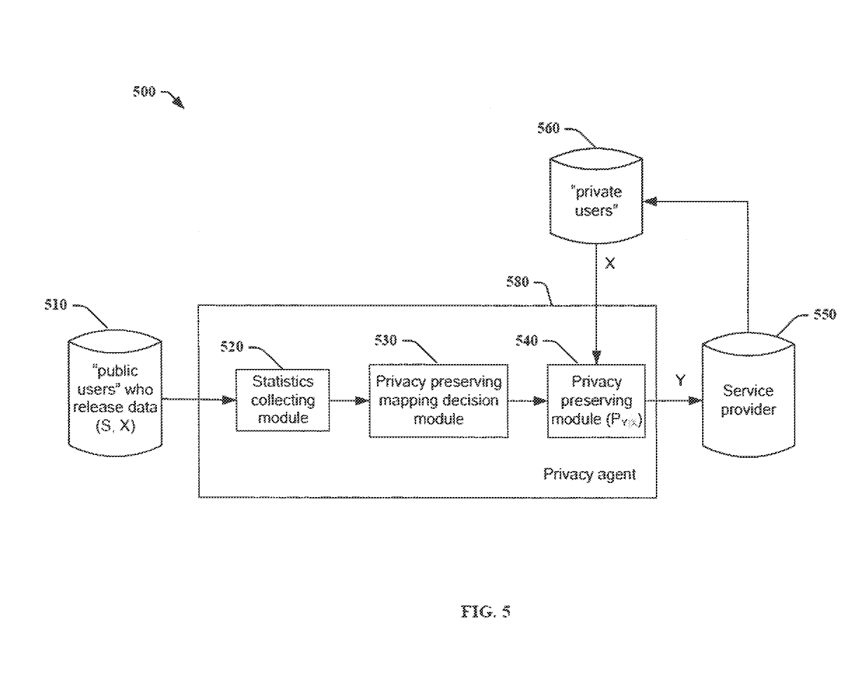

The present principles can be used in a privacy agent that protects the privacy of user data. FIG. 5 depicts a block diagram of an exemplary system 500 where a privacy agent can be used. Public users 510 release their private data (S) and/or public data (X). As discussed before, public users may release public data as is, that is, Y=X. The information released by the public users becomes statistical information useful for a privacy agent.

A privacy agent 580 includes statistics collecting module 520, privacy preserving mapping decision module 530, and privacy preserving module 540. Statistics collecting module 520 may be used to collect joint distribution P_{S,X}, marginal probability measure P_{X}, and/or mean and covariance of public data. Statistics collecting module 520 may also receive statistics from data aggregators, such as bluekai.com. Depending on the available statistical information, privacy preserving mapping decision module 530 designs a privacy preserving mapping mechanism P_{Y|X}. Privacy preserving module 540 distorts public data of private user 560 before it is released, according to the conditional probability P_{Y|X}. In one embodiment, statistics collecting module 520, privacy preserving mapping decision module 530, and privacy preserving module 540 can be used to perform steps 110, 120, and 130 in method 100, respectively.

Note that the privacy agent needs only the statistics to work without the knowledge of the entire data that was collected in the data collection module. Thus, in another embodiment, the data collection module could be a standalone module that collects data and then computes statistics, and needs not be part of the privacy agent. The data collection module shares the statistics with the privacy agent.

A privacy agent sits between a user and a receiver of the user data (for example, a service provider). For example, a privacy agent may be located at a user device, for example, a computer, or a set-top box (STB). In another example, a privacy agent may be a separate entity.

All the modules of a privacy agent may be located at one device, or may be distributed over different devices, for example, statistics collecting module 520 may be located at a data aggregator who only releases statistics to the module 530, the privacy preserving mapping decision module 530, may be located at a “privacy service provider” or at the user end on the user device connected to a module 520, and the privacy preserving module 540 may be located at a privacy service provider, who then acts as an intermediary between the user, and the service provider to whom the user would like to release data, or at the user end on the user device.

The privacy agent may provide released data to a service provider, for example, Comcast or Netflix, in order for private user 560 to improve received service based on the released data, for example, a recommendation system provides movie recommendations to a user based on its released movies rankings.

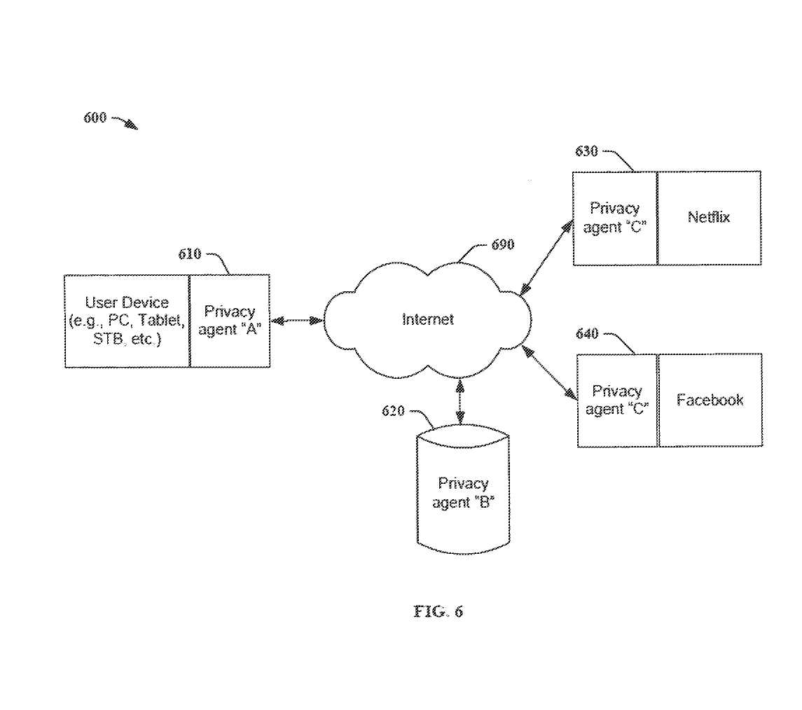

In FIG. 6, we show that there are multiple privacy agents in the system. In different variations, there need not be privacy agents everywhere as it is not a requirement for the privacy system to work. For example, there could be only a privacy agent at the user device, or at the service provider, or at both. In FIG. 6, we show that the same privacy agent “C” for both Netflix and Facebook. In another embodiment, the privacy agents at Facebook and Netflix, can, but need not, be the same.

Finding the privacy-preserving mapping as the solution to a convex optimization relies on the fundamental assumption that the prior distribution p_{A,B} that links private attributes A and data B is known and can be fed as an input to the algorithm. In practice, the true prior distribution may not be known, but may rather be estimated from a set of sample data that can be observed, for example from a set of users who do not have privacy concerns and publicly release both their attributes A and their original data B. The prior estimated based on this set of samples from non-private users is then used to design the privacy-preserving mechanism that will be applied to new users, who are concerned about their privacy. In practice, there may exist a mismatch between the estimated prior and the true prior, due for example to a small number of observable samples, or to the incompleteness of the observable data.

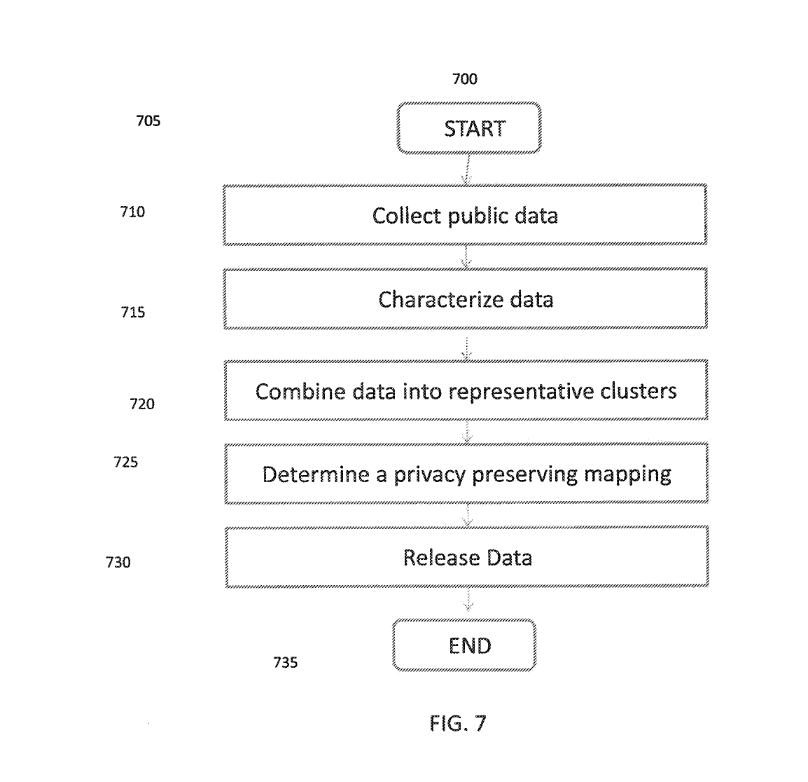

Turning now to FIG. 7 a method for privacy preserving in light of large data 700. A problem of scalability that occurs when the size of the underlying alphabet of the user data is very large, for example, due to a large number of available public data items. To handle this, a quantization approach that limits the dimensionality of the problem is shown. To address this limitation, the method teaches to address the problem approximately by optimizing a much smaller set of variables. The method involves three steps. First, reducing the alphabet B into C representative examples, or clusters. Second, a privacy preserving mapping is generated using the clusters. Finally, all examples b in the input alphabet B to C based on the learned mapping for C representative example of b.

First, method 700 starts at step 705. Next, all available public data is collected and gathered from all available sources 710. The original data is then characterized 715 and clustered into a limited number of variables 720, or clusters. The data can be clustered based on characteristics of the data which may be statistically similar for purposes of privacy mapping. For example, movies which may indicate political affiliation may be clustered together to reduce the number of variables. An analysis may be performed on each cluster to provide a weighted value, or the like, for later computational analysis. The advantage of this quantization scheme is that it is computationally efficient by reducing the number of optimized variables from being quadratic in the size of the underlying feature alphabet to being quadratic in the number of clusters, and thus making the optimization independent of the number of observable data samples. For some real world examples, this can lead to orders of magnitude reduction in dimensionality.

The method is then used to determine how to distort the data in the space defined by the clusters. The data may be distorted by changing the values of one or more clusters or deleting the value of the cluster before release. The privacy-preserving mapping 725 is computed using a convex solver that minimizes privacy leakage subject to a distortion constraint. Any additional distortion introduced by quantization may increase linearly with the maximum distance between a sample data point and the closest cluster center.

Distortion of the data may be repeatedly preformed until a private data point cannot be inferred above a certain threshold probability. For example, it may be statistically undesirable to be only 70% sure of a person's political affiliation. Thus, clusters or data points may be distorted until the ability to infer political affiliation is below 70% certainty. These clusters may be compared against prior data to determine inference probabilities.

Data according to the privacy mapping is then released 730 as either public data or protected data. The method of 700 ends at 735. A user may be notified of the results of the privacy mapping and may be given the option of using the privacy mapping or releasing the undistorted data.

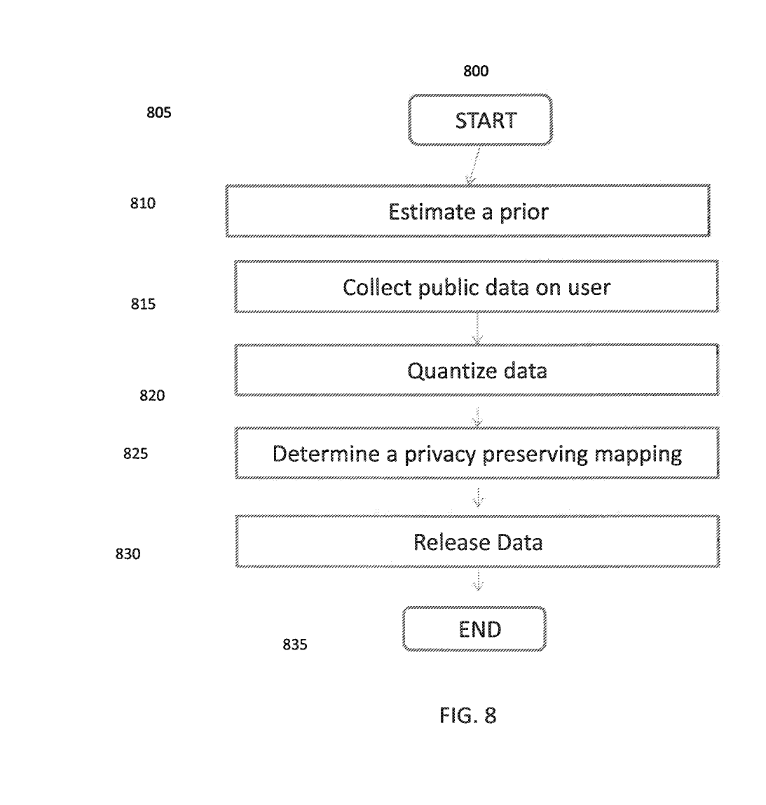

Turning now to FIG. 8, a method 800 for determining a privacy mapping in light of a mismatched prior is shown. The first challenge is that this method relies on knowing a joint probability distribution between the private and public data, called the prior. Often the true prior distribution is not available and instead only a limited set of samples of the private and public data can be observed. This leads to the mismatched prior problem. This method addresses this problem and seeks to provide a distortion and bring privacy even in the face of a mismatched prior. Our first contribution centers around starting with the set of observable data samples, we find an improved estimate of the prior, based on which the privacy-preserving mapping is derived. We develop some bounds on any additional distortion this process incurs to guarantee a given level of privacy. More precisely, we show that the private information leakage increases log-linearly with the L1-norm distance between our estimate and the prior; that the distortion rate increases linearly with the L1-norm distance between our estimate and the prior; and that the L1-norm distance between our estimate and the prior decreases as the sample size increases.

The method of 800 starts at 805. The method first estimates a prior from data of non private users who publish both private and public data. This information may be taken from publically available sources or may be generated through user input in surveys or the like. Some of this data may be insufficient if not enough samples can be attained or if some users provide incomplete data resulting from missing entries. This problems may be compensated for if a larger number of user data is acquired. However, these insufficiencies may lead to a mismatch between a true prior and the estimated prior. Thus, the estimated prior may not provide completely reliable results when applied to the complex solver.

Next, public data is collected on the user 815. This data is quantized 820 by comparing the user data to the estimated prior. The private data of the user is then inferred as a result of the comparison and the determination of the representative prior data. A privacy preserving mapping is then determined 825. The data is distorted according to the privacy preserving mapping and then released to the public as either public data or protected data 830. The method ends at 835.

As described herein, the present invention provides an architecture and protocol for enabling privacy preserving mapping of public data. While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for processing user data comprising the steps of:
accessing the user data wherein the user data comprises a plurality of public data;
clustering the user data into a plurality of clusters; and
processing the clusters of data to infer a private data, wherein said processing determines a probability of said private data.

2. The method of claim 1 further comprising the step of:
altering one of said clusters to generate an altered cluster, said altered cluster altered such that said probability is reduced.

3. The method of claim 2 further comprising the step of:
transmitting said altered cluster via a network.

4. The method of claim 1 wherein said processing step comprises the step of comparing said plurality of clusters to a plurality of saved clusters.

5. The method of claim 4 wherein said comparing step determines the joint distribution of said plurality of saved clusters of data and said plurality of clusters.

6. The method of claim 1 further comprising the steps of altering said user data in response to said probability of said private data to generate altered user data, and transmitting said altered user data via a network.

7. The method of claim 1 wherein said clustering involves reducing said plurality of public details into a plurality of representative public clusters and privacy mapping the plurality of representative public clusters to generate an altered plurality of representative public clusters.

8. An apparatus for processing user data for a user, comprising:
a memory for storing a plurality of user data wherein the user data comprises a plurality of public data;
a processor for grouping said plurality of user data into a plurality of data clusters wherein each of said plurality of data clusters consists of at least two of said user data; said processor further operative to determine a statistical value in response to an analysis of said plurality of data clusters wherein said statistical value represents the probability of an instance of a private data, said processor further operative to alter at least one of said user data to generate an altered plurality of user data; and
a transmitter for transmitting said altered plurality of user data.

9. The apparatus of claim 8 wherein said altering at least one of said user data results in a reducing of said probability of said instance of said private data.

10. The apparatus of claim 8 wherein said altered plurality of user data is transmitted via a network.

11. The apparatus of claim 8 wherein said processor being further operative to compare said plurality of data clusters to a plurality of saved data clusters.

12. The apparatus of claim 11 wherein processor is operative to determine the joint distribution of said plurality of saved clusters of data and said plurality of clusters.

13. The apparatus of claim 8 wherein said processor is further operative to altering a second of said user data in response to said probability of said instance of said private data having a value higher than a predetermined threshold.

14. The apparatus of claim 8 wherein said grouping involves reducing said plurality of public details into a plurality of representative public clusters and privacy mapping the plurality of representative public clusters to generate an altered plurality of representative public clusters.

15. A method of processing user data comprising the steps of:
compiling a plurality of public data wherein each of said plurality of public data consist of a plurality of characteristics;
generating a plurality of data clusters wherein said data clusters consist of at least two of said plurality of public data and wherein said at least two of said plurality of public data each having at least one of said plurality of characteristics;
processing said plurality of data clusters to determine a probability of a private data; and
altering at least one of said plurality of public data to generate an altered public data in response to said probability exceeding a predetermined value.

16. The method of claim 15 further comprising the step of:
deleting at least one of said plurality of public data to generate an altered cluster, said altered cluster altered such that said probability is reduced.

17. The method of claim 15 further comprising the step of:
transmitting said altered public data via a network.

18. The method of claim 17 further comprising the step of receiving a recommendation in response to said transmitting said public data.

19. The method of claim 15 wherein said processing step comprises the step of comparing said plurality of clusters to a plurality of saved clusters.

20. The method of claim 19 wherein said comparing step determines the joint distribution of said plurality of saved clusters of data and said plurality of clusters.

21. The method of claim 15 wherein said generating step further comprises the steps of:
reducing said plurality of public data into a plurality of representative public clusters;
privacy mapping the plurality of representative public clusters to generate an altered plurality of representative public clusters; and
transmitting said altered public data via a network.

22. (canceled)
